(19) United States
(12) Patent Application Publication
(10) Pub. No.: US 2006/0176276 A1
(43) Pub. Date: Aug. 10, 2006

(54) Computer mouse assembly

(76) Inventor: De-Wu Hu, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/052,891

(22) Filed: Feb. 9, 2005

(51) Int. Cl. G09G 5/08

(52) U.S. Cl. 345/163

(57) ABSTRACT

A computer mouse assembly is provided with a fastening and releasing mechanism for battery compartment cover arranged on the computer mouse assembly. The computer mouse assembly includes a seat, a middle seat cover connected to a top of the seat and defining a battery compartment for receiving at least one battery therein, a battery compartment cover connected to a top of the middle seat cover to close the battery compartment and having a downward projected retaining hook, and a release push button located on the seat near the battery compartment and including a push head and an upward hook normally engaged with the retaining hook below the battery compartment cover. When the release push button is forward pushed, the retaining hook of the battery compartment cover is disengaged from the upward hook of the release push button and upward pushed by an elastic member, so that the battery compartment cover is sprung open.

### FIELD OF THE INVENTION

The present invention relates to a structural design for a computer mouse, and more particularly to a fastening and releasing mechanism for a battery compartment cover of a wireless computer mouse assembly that enables convenient replacement of batteries for the computer mouse.

### BACKGROUND OF THE INVENTION

A mouse is one of many necessary peripherals for a computer system. By moving the mouse on a computer desk, a user may conveniently control positions of a cursor on a computer screen. Currently, a wireless mouse is widely adopted among users because it could be advantageously smoothly operated on the computer desk without connecting to or being restricted by a transmission line that usually extends across the computer desk and tends to tangle other things on the desk.

A wireless mouse internally includes transmitting and receiving antennas, a carrier generator, an antenna driving amplifier, a detector, a comparator, a decoder, and other radio circuits, which are mounted on a circuit base board in a main body of the mouse. Signals from the mouse are sent by the transmitting/receiving antennas via radio waves to a receiver on a mainframe of the computer system to control operations of the latter. The wireless mouse is battery-powered to work normally.

While the wireless mouse provides more conveniences in operation thereof, it requires frequent replacement of batteries and therefore causes troubles to users. To replace the batteries for the currently available wireless mouse, a user has to remove a battery compartment cover from the mouse by using a screwdriver to dismount all screws from the mouse, so as to separate upper and lower housings or seat and middle seat cover of the mouse from each other to remove the old batteries from the mouse. It is possible the internal radio circuits are damaged or some parts or components are lost in the course of disassembling the mouse for replacing batteries.

It is also time and labor consuming to loosen the screws and separate the upper housing from the lower housing or the seat from the middle seat cover of the mouse using one or more tools. In a worse condition, the mouse might become useless due to lost parts or components and/or damaged internal radio circuits.

While some battery compartment covers have been designed for wireless computer mouse in an attempt to enable quick opening of the cover and convenient replacement of batteries, they are actually complicate in structure and inconvenient to operate, and disadvantageously increase the volume and weight of the whole wireless mouse.

It is therefore tried by the inventor to develop an improved fastening and releasing mechanism for battery compartment cover on a computer mouse to eliminate the above-mentioned drawbacks existed in the currently available wireless computer mouse.

### SUMMARY OF THE INVENTION

A primary object of the present invention is to provide a fastening and releasing mechanism for battery compartment cover on a computer mouse that allows the battery compartment cover to quickly upward spring open for replacement of new batteries when a release push button is pushed with only one finger.

Another object of the present invention is to provide a fastening and releasing mechanism for battery compartment cover on a computer mouse that normally firmly holds the battery compartment cover in a closed position but allows the battery compartment cover to automatically spring open simply by pushing a release push button with one finger. Therefore, the batteries could be conveniently removed from the battery compartment without touching any of the circuit components or losing any parts in the wireless mouse. That is, the computer mouse could be used in safer manner to prolong its usable life.

To achieve the above-identified objects, in accordance with the present invention, there is provided a fastening and releasing mechanism for battery compartment cover on a computer mouse assembly. The fastening and releasing mechanism includes a seat, a middle seat cover connected to a top of the seat and defining a battery compartment for receiving at least one battery therein, a battery compartment cover connected to a top of the middle seat cover to close the battery compartment and having a downward projected retaining hook, and a release push button located on the seat near the battery compartment and including a push head and an upward hook normally engaged with the retaining hook below the battery compartment cover.

With the present invention, the batteries for the wireless mouse could be easily replaced without the need of using any tool to dismount any screw to disassemble the mouse in a time and labor consumed manner, or subjecting to the risk of losing parts and damaging internal circuits in the mouse.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a computer mouse having a battery compartment cover equipped with a fastening and releasing mechanism of the present invention;

FIGS. 2, 3, 4, and 5 are side, front, rear, and bottom views, respectively, of the computer mouse of FIG. 1;

FIG. 6 is an exploded perspective view of the computer mouse of FIG. 1 showing all related components and parts included in the present invention;

FIG. 7 is a sectional view taken along line 7-7 of FIG. 1;

FIG. 8 is an enlarged view of the encircled area A of FIG. 7;

FIG. 9 is an enlarged view of the encircled area B of FIG. 7;

FIG. 10 is a sectional view showing the battery compartment cover of the computer mouse is lifted when a release push button of the fastening and releasing mechanism is forward pushed; and

FIG. 11 is an enlarged view of the encircled area C of FIG. 10.

### DETAILED DESCRIPTION OF THE PREFERRED EMBODIMENTS

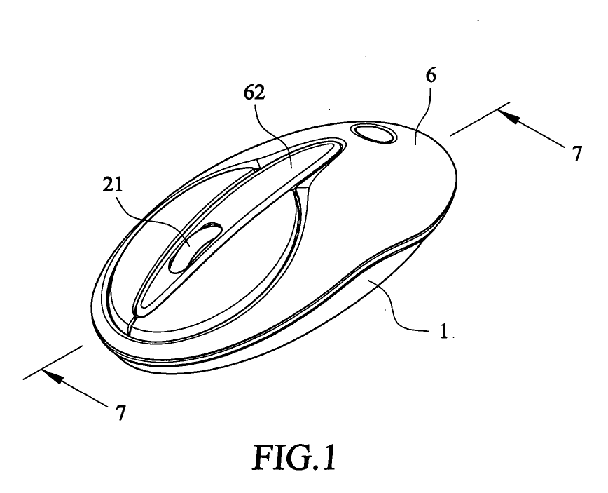

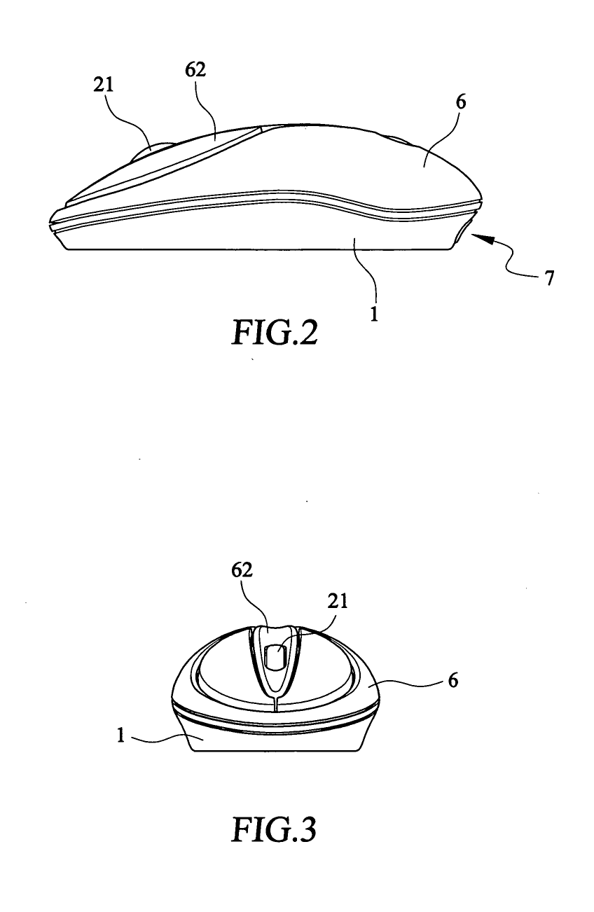

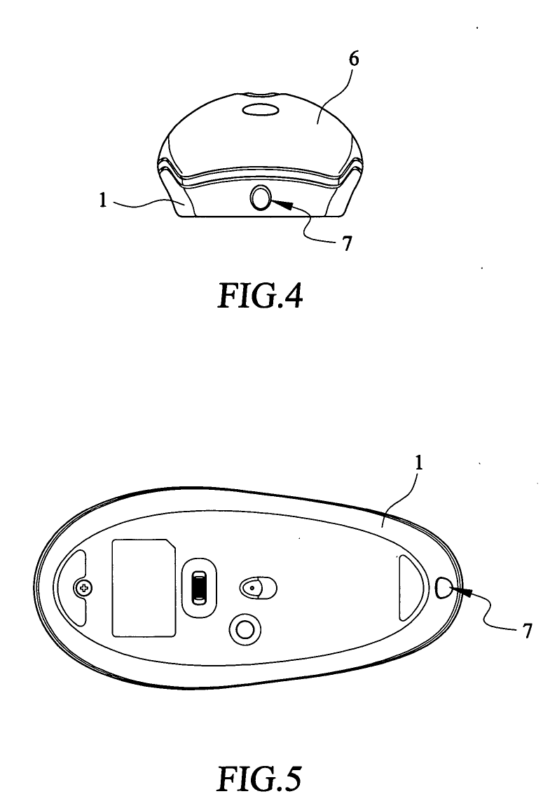

Please refer to FIGS. 1 and 6 that are assembled and exploded perspective views, respectively, of a wireless computer mouse having a battery compartment cover equipped with a fastening and releasing mechanism according to the present invention, and to FIGS. 2 through 5 that are side, front, rear, and bottom views, respectively, of the computer mouse of FIG. 1. It is noted a wireless computer mouse is taken as an example in the following description of the present invention. As shown in the illustrated drawings, the computer mouse includes a seat 1 having an axially extended through hole 11 provided at a rear end thereof.

A circuit base board 2 is mounted on the seat 1 and has an operating wheel 21, two conducting coil springs 22a, 22b, and other related electronic elements, integrated circuits, gearing components, etc. for general mouse control circuits arranged thereon.

A middle seat cover 3 is connected to a top of the seat 1, so that the circuit base board 2 is enclosed in a space defined between the middle seat cover 3 and the seat 1.

The middle seat cover 3 is formed at a rear end with a rear battery-holding recess 31, and has an auxiliary battery holder 4 associated therewith. The auxiliary battery holder 4 has a top formed into a front battery-holding recess 41, and a front end provided with a retaining hook 42 for firmly coupling the auxiliary battery holder 4 to the middle seat cover 3, so at to associate with the rear battery-holding recess 31. The middle seat cover 3 is also provided at a rear side of the rear battery-holding recess 31 with a pair of conducting strip seats 32a, 32b, in which a conducting strip carrier 33 having a pair of conducting strips 33a, 33b provided thereon is set. A retaining hook 34 is provided at a front end of the middle seat cover 3.

The rear battery-holding recess 31 and the front battery-holding recess 41 together define a space between them to serve as a battery compartment on the computer mouse for receiving two juxtaposed batteries 5 therein. The two batteries 5 received in the battery compartment are electrically connected to each other via the conducting strip seats 32a, 32b and the conducting coil springs 22a, 22b to supply power needed by the computer mouse to operate normally.

A battery compartment cover 6 is connected to a top of the middle seat cover 3 to shield the rear battery-holding recess 31 at the rear end of the middle seat cover 3. A two-key cover 61 and an ornament 62 are connected to a front top of the battery compartment cover 6, and a retaining hook 621 is provided at a lower front end of the ornament 62 to hold the ornament 62 to the middle seat cover 3. And, a retaining hook 63 is downward projected from an inner rear top of the battery compartment cover 6.

A release push button 7 for releasing the battery compartment cover 6 from the middle seat cover 3 is mounted in the axially extended through hole 11 at the rear end of the seat 1, and is horizontally slidable in the through hole 11 when being pushed forward. The release push button 7 includes a push head 71, an upward projected arm 72 located in front of and above the push head 71 and having a hook 73 provided at a top thereof and a slot 74 formed at a middle section thereof, and a guidepost 75 forward extended from the push head 71 to locate in the through hole 11 on the seat 1. When the push head 71 of the release push button 7 is forward pushed, the guidepost 75 guides the whole release push button 7 to horizontally slide in the through hole 11. An elastic member 8 is put around the guidepost 75 and includes a coil spring 81 and an elastic push section 82. The coil spring 81 has a rear and a front end pressed against the push head 71 and a stopper 13 on the seat 1, respectively. The elastic push section 82 is integrally extended from the front end of the coil spring 81, and is first bent to extend upward by a predetermined distance and then bent again to extend horizontally and rearward, so that a free end of the elastic push section 82 is extended through the slot 74 on the push button 7.

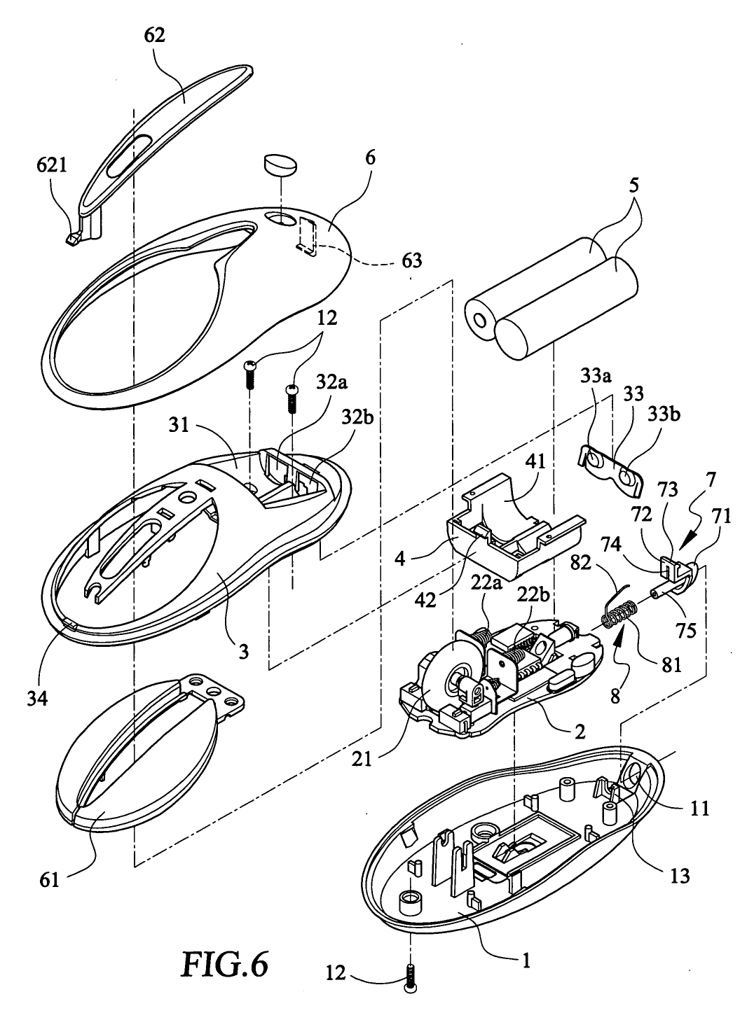

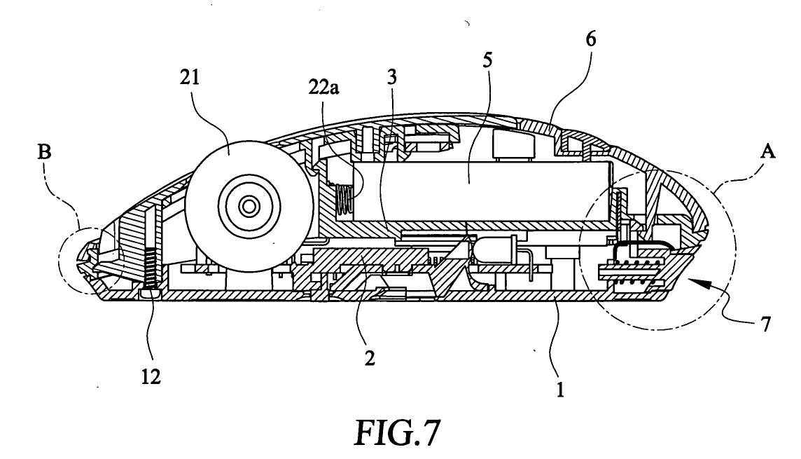

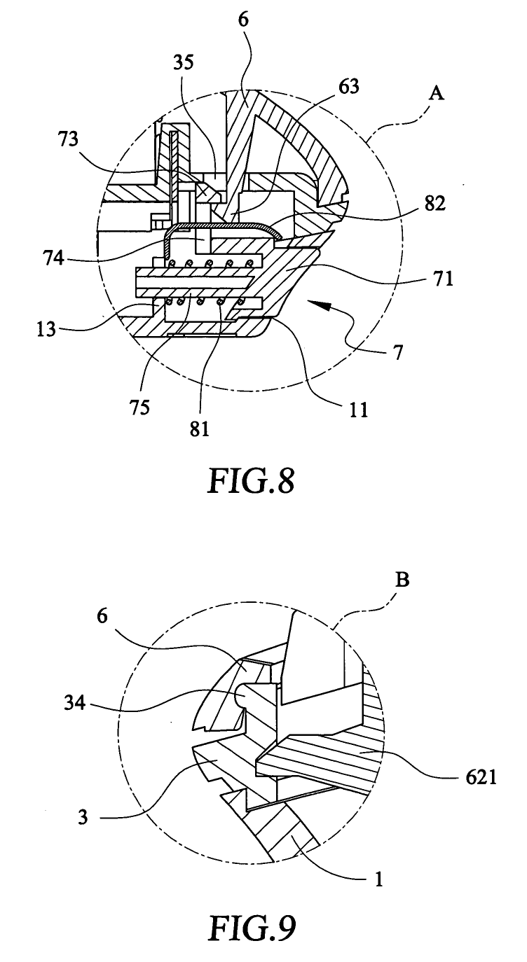

FIG. 7 is a sectional view taken along line 7-7 of FIG. 1, and FIGS. 8 and 9 are enlarged views of the encircled areas A and B of FIG. 7, respectively. When all the above-mentioned components are assembled together, the seat 1 and the middle seat cover 3 are firmly connected together using conventional fastening or screwing elements 12. When the computer mouse is fully assembled, the retaining hook 63 downward projected from the inner rear top of the battery compartment cover 6 extends through an opening 35 provided on the middle seat cover 3 to engage with the hook 73 of the push button 7, as shown in FIG. 8. A lower end of the retaining hook 63 is normally in contact with and pushed upward by the elastic push section 82 of the elastic member 8.

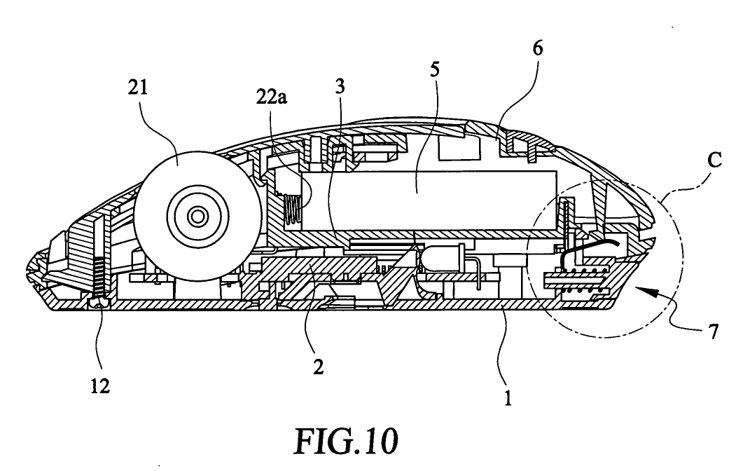

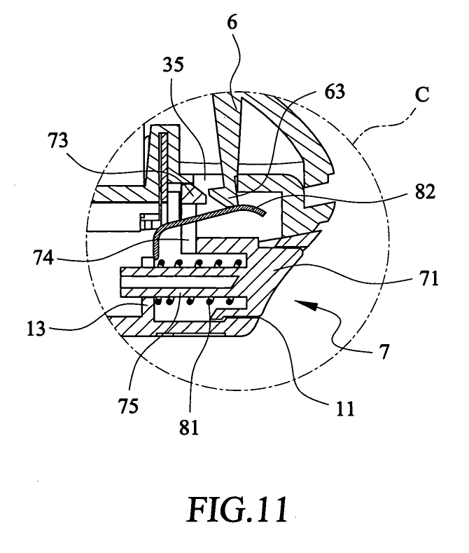

Please refer to FIG. 10 that is a sectional view showing the battery compartment cover 6 of the computer mouse is lifted when the release push button 7 is forward pushed; and to FIG. 11 that is an enlarged view of the encircled area C of FIG. 10. When the batteries 5 are exhausted, they must be replaced with new ones to keep the mouse working normally. To replace the exhausted batteries 5, simply forward push the push head 71 of the release push button 7, and the whole release push button 7 is guided by the guidepost 75 to move forward in the through hole 11 on the seat 1.

When the release push button 7 is pushed forward, the upward projected arm 72 is moved forward at the same time to disengage the hook 73 at the top of the upward projected arm 72 from the retaining hook 63 below the battery compartment cover 6, so that the retaining hook 63 is pushed upward by the elastic push section 82 of the elastic member 8, which normally elastically presses against the lower end of the retaining hook 63, and a rear end of the battery compartment cover 6 springs open at the same time. At this point, the exhausted batteries 5 could be easily removed from the rear battery-holding recess 31 of the middle seat cover 3 and replaced with new ones.

After the replacement of batteries 5, the battery compartment cover 6 could be closed to the middle seat cover 3 again simply by depressing the rear end of the battery compartment cover 6 with a minor force to engage the retaining hook 63 with the hook 73 on the release push button 7. Meanwhile, the elastic push section 82 of the elastic member 8 presses the lower end of the retaining hook 63 against the hook 73 again to prevent the retaining hook 63 from easily disengaging from the hook 73.

With the above arrangements, the fastening and releasing mechanism for battery compartment cover on a computer mouse according to the present invention enables a user to conveniently replace batteries without using any tool or dismounting any components or parts of the mouse, and is therefore practical for use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A computer mouse assembly, comprising:
a seat:
a middle seat cover defining a battery compartment for receiving at least one battery therein;
a battery compartment cover connected to a top of said middle seat cover to close said battery compartment, and being provided at an inner rear top with a downward projected retaining hook;
a release push button located on said seat in the proximity of said battery compartment on said middle seat cover, and including a push head and an upward projected hook corresponding to said retaining hook on said battery compartment cover; and
an elastic member associated with said release push button and having an elastic push section extended rearward to normally press against a lower end of said retaining hook on said battery compartment cover; and
said retaining hook of said battery compartment cover being engaged with said upward projected hook of said release push button to hold said battery compartment cover to said middle seat cover when a downward force is applied on said battery compartment cover; and said retaining hook of said battery compartment cover being disengaged from said upward projected hook of said release push button for a rear end of said battery compartment cover to spring open from said middle seat cover when said push head of said release push button is forward pushed and said elastic push section applies an upward elastic force against said lower end of said retaining hook below said battery compartment cover.

2. The computer mouse assembly as claimed in claim 1, wherein said seat is provided with a through hole, in which said release push button is located.

3. The computer mouse assembly as claimed in claim 1, wherein said release push button includes an upward projected arm located in front of and above said push head, and said upward projected hook being formed at a top of said upward projected arm.

4. The computer mouse assembly as claimed in claim 3, wherein said upward projected arm of said release push button is provided with a slot, through which said elastic push section of said elastic member extends to press against the lower end of said retaining hook of said battery compartment cover.

5. The computer mouse assembly as claimed in claim 1, wherein said release push button further includes a guidepost forward extended from said push head for guiding said release push button to move forward on said seat in a horizontal direction when a forward force is applied on said push head.

6. The computer mouse assembly as claimed in claim 5, wherein said elastic member includes a coil spring, and said coil spring being put around said guidepost of said release push button.

7. The computer mouse assembly as claimed in claim 6, wherein said elastic push section is integrally extended from an end of said coil spring of said elastic member.
